(19) United States
(12) Patent Application Publication
(10) Pub. No.: US 2025/0244442 A1
(43) Pub. Date: Jul. 31, 2025

(54) RADAR BEACON AND RADAR MEASUREMENT SYSTEM

(71) Applicant: SHANGHAI YUEXUAN TECHNOLOGY CO., LTD., Shanghai (CN)

(72) Inventor: Lei Ye, Shanghai (CN)

(21) Appl. No.: 18/034,688

(22) PCT Filed: May 8, 2021
(86) PCT No.: PCT/CN2021/092422

§ 371 Date: Sep. 15, 2023

(30) Foreign Application Priority Data
Nov. 2, 2020 (CN) 202011205150.8

(51) Int. Cl. G01S 7/03

(52) U.S. Cl. CPC G01S 7/03

(57) ABSTRACT

Disclosed are a radar beacon and a radar measurement system. An incident electromagnetic wave is refracted to a reflection apparatus using a spherical lens, and the refracted electromagnetic wave is reflected via the reflection apparatus and then refracted by means of the spherical lens to form an echo signal so as to achieve radar measurement, where a focal point of the spherical lens is located on a curved surface concentric with the spherical lens. The reflection apparatus is provided with a reflecting surface with the same curvature as the curved surface, and is arranged on the curved surface, and the reflecting surface coincides with a portion of the curved surface. Therefore, the radar beacon may be conveniently installed, the cost of the radar beacon is reduced, and the reflection efficiency of the radar beacon and the measurement precision of the radar measurement system are improved.

### CLAIM OF PRIORITY AND CROSS-REFERENCE TO RELATED APPLICATION(S)

This application claims the benefit of Chinese Patent Application No. 202011205150.8, filed on Nov. 2, 2020, which is incorporated herein by reference in its entirety.

### BACKGROUND OF THE DISCLOSURE

### 1. Field of the Disclosure

The present disclosure relates to the technical field of radar, and in particular to a radar beacon and a radar measurement system.

### 2. Description of the Related Art

A radar beacon is an electronic device installed on a target (an airplane, a missile, etc.) that can emit an electromagnetic signal and work with radar, also known as a beacon machine or a transponder. At present, the radar beacon has been widely used in aviation control, radio navigation, missile guidance, external ballistic measurement, satellite orbit measurement, radar remote sensing and so on. The radar beacon may be divided into an active beacon and a passive beacon according to whether a signal transmitting method is directly used.

An existing passive beacon is usually realized by a corner reflector, and the corner reflectors are radar wave reflectors of different specifications made of metal sheets according to different purposes. When a radar electromagnetic wave scans the corner reflector, the electromagnetic wave may be refracted and amplified on a metal corner to generate an echo signal so as to realize radar measurement.

However, the corner reflector needs to be adjusted to an appropriate reflected angle with the radar. Only when the radar wave can be shot into the corner reflector in parallel, the radar can obtain a corresponding strong reflected signal to achieve the purpose of tracking and measurement, and the installation process is rather cumbersome. Meanwhile, the reflection efficiency of the corner reflector is low. The farther the distance is, the larger the required area of the corner reflector is. When the side length of the corner reflector exceeds a certain value, much inconvenience may be brought for installation due to the characteristics of its metal material, its own weight and area. Moreover, due to a geometric shape of the corner reflector, the corner reflector has high requirements on the external environment. For example, in the presence of wind, the corner reflector may form jitter, which may cause a measurement error. For another example, it is necessary to maintain a relative clearance within the visual distance between the corner reflector and the radar, and no vegetation, standing water, etc. should appear.

### BRIEF DESCRIPTION OF THE DISCLOSURE

In view of this, embodiments of the present disclosure aim to provide a radar beacon and a radar measurement system, which can facilitate the installation of the radar beacon, reduce the cost of the radar beacon, and improve the reflection efficiency of the radar beacon and the measurement accuracy of the radar system.

According to a first aspect, an embodiment of the present disclosure provides a radar beacon. The radar beacon includes:
a spherical lens, of which a focal point is located on a curved surface concentric with the spherical lens; and
a reflection apparatus, which is provided with a reflecting surface with the same curvature as the curved surface, is arranged on the curved surface, where the reflecting surface coincides with a portion of the curved surface, and is configured to reflect an electromagnetic wave incident through the spherical lens.

Optionally, the material of the spherical lens is Polytetrafluoroethylene (PTFE).

Optionally, a distance between the curved surface and a surface of the spherical lens is 0.4 R to 0.5 R,
where R is the radius of the spherical lens.

Optionally, the radar beacon further includes:
at least one fixing member, which is connected between the reflection apparatus and the spherical lens, and is configured to fix a relative position of the reflection apparatus and the spherical lens.

Optionally, the radar beacon further includes:
a support member, which is arranged under the spherical lens, and is configured to support the radar beacon.

Optionally, the reflecting surface of the reflection apparatus is made by a copper plating process.

Optionally, the reflection apparatus further includes a reflecting base plate, and the reflecting surface is attached to the reflecting base plate.

Optionally, an outer edge of the reflecting base plate is circular.

Optionally, the reflection apparatus is a portion of a target object.

According to a second aspect, an embodiment of the present disclosure provides a radar measurement system. The radar measurement system includes:
a measurement radar; and
as least one radar beacon as described in the first aspect.

According to the technical solution of the embodiments of the present disclosure, an incident electromagnetic wave is refracted to the reflection apparatus using the spherical lens, and the refracted electromagnetic wave is reflected via the reflection apparatus and then refracted by means of the spherical lens to form an echo signal so as to achieve the radar measurement, where a focal point of the spherical lens is located on the curved surface concentric with the spherical lens, the reflection apparatus is provided with a reflecting surface with the same curvature as the curved surface, and is arranged on the curved surface, and the reflecting surface coincides with a portion of the curved surface. Therefore, the radar beacon may be conveniently installed, the cost of the radar beacon is reduced, and the reflection efficiency of the radar beacon and the measurement precision of the radar measurement system are improved.

### BRIEF DESCRIPTION OF THE DRAWINGS

The foregoing and other objectives, features and advantages of the present disclosure will become more apparent from the following description of embodiments of the present disclosure with reference to the accompanying drawings, in which:

FIG. 1 is a schematic diagram of a radar measurement system according to an embodiment of the present disclosure;

FIG. 2 is a schematic diagram of measurement radar according to an embodiment of the present disclosure;

FIG. 3 is a schematic diagram of a radar beacon according to a first embodiment of the present disclosure;

FIG. 4 is a schematic diagram of a spherical lens and a spherical surface according to an embodiment of the present disclosure;

FIG. 5 is a directional perspective view of a reflection apparatus according to an embodiment of the present disclosure;

FIG. 6 is another directional perspective view of a reflection apparatus according to an embodiment of the present disclosure;

FIG. 7 is a schematic diagram of a reflection apparatus according to an embodiment of the present disclosure;

FIG. 8 is a schematic diagram of a radar beacon according to a second embodiment of the embodiments of the present disclosure;

FIG. 9 is a contrast diagram of a test result according to an embodiment of the present disclosure; and

FIG. 10 is another contrast diagram of a test result according to another embodiment of the present disclosure.

### DETAILED DESCRIPTION OF EMBODIMENTS OF THE DISCLOSURE

The present disclosure is described below based on embodiments, but the present disclosure is not only limited to these embodiments. In the following detailed description of the present disclosure, some specific details are described in detail. The present disclosure may be fully understood by those skilled in the art without the description of these detailed parts. In order to avoid confusing the substance of the present disclosure, well-known methods, processes, flows, elements and circuits are not described in detail.

In addition, it should be understood by those of ordinary skill in the art that the drawings provided herein are for illustrative purposes, and the drawings are not necessarily drawn to scale.

Unless expressly required in the context, the terms “include”, “comprise”, and other similar words should be construed as inclusive rather than exclusive or exhaustive, that is, the meaning of “including, but not limited to”.

In the description of the present disclosure, it should be understood that the terms “first”, “second”, and the like are merely used for descriptive purposes, but cannot be understand as indicating or implying relative importance. Moreover, in the description of the present disclosure, unless otherwise stated, “a plurality of” means two or more.

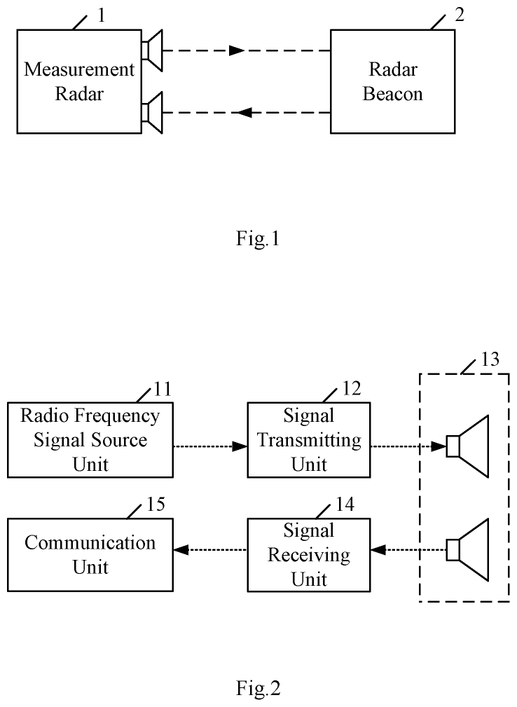

FIG. 1 is a schematic diagram of a radar measurement system according to an embodiment of the present disclosure. As shown in FIG. 1, the radar measurement system according to the embodiment of the present disclosure includes measurement radar 1 and a radar beacon 2. The measurement radar 1 is configured to transmit an electromagnetic wave and receive an echo signal returned by the radar beacon 2. The radar beacon 2 is configured to reflect the electromagnetic wave transmitted by the measurement radar 1 and then form the echo signal to send to the measurement radar 1.

Further, the radar measurement system further includes a server, which is in communication connection with the measurement radar 1, and is configured to receive the echo signal from the measurement radar 1, and analyze the echo signal to realize radar measurement.

FIG. 2 is a schematic diagram of measurement radar according to an embodiment of the present disclosure. As shown in FIG. 2, the measurement radar 1 according to the embodiment of the present disclosure includes a radio frequency signal source unit 11, a signal transmitting unit 12, an antenna 13, a signal receiving unit 14 and a communication unit 15.

In the present embodiment, the radio frequency signal source unit 11 is configured to generate an electromagnetic wave.

Further, the frequency of the electromagnetic wave may be the operating frequency of various existing radar, such as High Frequency (HF), Very High Frequency (VHF), Ultra High Frequency (UHF, also called P), L-band, S-band, C-band, X-band, Ku-band, K-band, Ka-band, U-band, V-band and W-band.

In the present embodiment, the signal transmitting unit 12 transmits the electromagnetic wave.

In the present embodiment, the signal receiving unit 14 is configured to receive an echo signal.

Further, the signal transmitting unit 12 and the signal receiving unit 14 are connected to the antenna 13. The signal transmitting unit 12 is configured to transmit the electromagnetic wave via the antenna 13. The signal receiving unit 14 is configured to receive the echo signal via the antenna 13.

Further, the antenna 13 may be various existing radar antennas, such as a horn antenna and a microstrip antenna.

In the present embodiment, the communication unit 15 is configured to communicate with the server, so as to send the echo signal to the server, or to receive a control signal of the server.

Further, the communication unit 15 may use various existing wired communication or wireless communication manners for communication.

Optionally, the measurement radar 1 further includes a control unit for performing real-time processing on the signal, for example, performing operations such as filtering the echo signal and parsing the received control signal.

Further, the measurement radar 1 further includes a power supply unit for supplying power to each module in the measurement radar 1.

Thus, the signal transmission and reception may be realized by the measurement radar 1.

It should be understood that FIG. 2 is only an example of the measurement radar in the embodiment of the present disclosure, which is not limited in the embodiment of the present disclosure, and the measurement radar may be realized by various existing radar apparatuses.

FIG. 3 is a schematic diagram of a radar beacon according to a first embodiment of the present disclosure. As shown in FIG. 3, the radar beacon 2 in the embodiment of the present application includes a spherical lens 21 and a reflection apparatus 22.

In the present embodiment, a focal point of the spherical lens 21 is located on a curved surface concentric with the spherical lens 21.

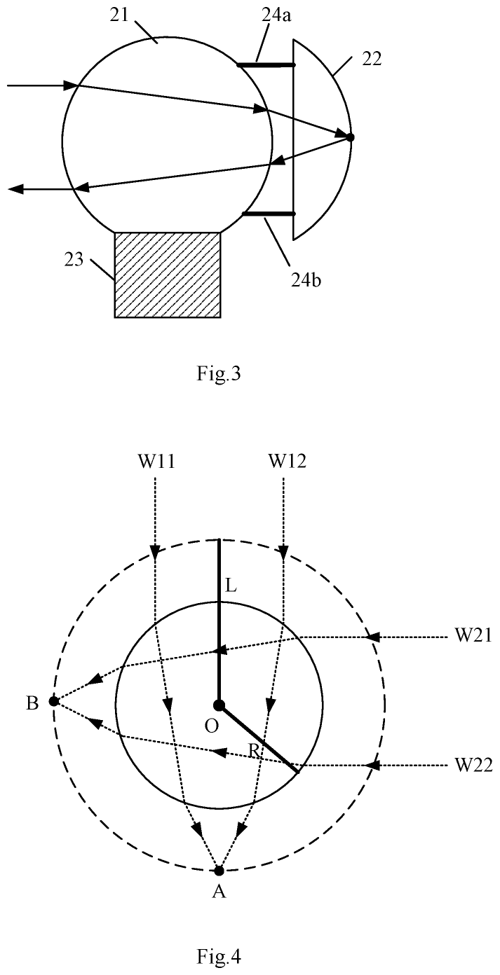

Specifically, FIG. 4 is a schematic diagram of a spherical lens and a curved surface according to an embodiment of the present disclosure. As shown in FIG. 4, a solid circle represents the spherical lens, and a dotted circle represents the curved surface formed by the focal points of the spherical lens in different directions, which is hereinafter referred to as the curved surface. The spherical lens and the curved surface have a common spherical center O. Further, the curved surface is concentric with the spherical lens, and the radius of the curved surface is great than the radius of the spherical surface of the spherical lens.

In the present embodiment, the radius of the spherical surface is as L in the figure, and the radius of the spherical lens is as R in the figure.

Further, the radius of the spherical surface is greater than the radius of the spherical lens.

Further, the spherical lens is a single medium spherical lens, where the single medium spherical lens refers to a spherical lens made of a same material. Thus, the focal points of the spherical lens in different directions may form a regular spherical surface, and the spherical surface and the spherical lens have a same circle center.

Further, the curved surface is a portion of the spherical surface formed by the focal point.

Further, two sets of transmission paths of electromagnetic waves in different directions are shown in the figure, where a first set of electromagnetic waves are W11 and W12, the electromagnetic wave W11 and the electromagnetic wave W12 are shot into the spherical lens in parallel, and after being refracted by the spherical lens, the focal point is point A. A second set of electromagnetic waves are W21 and W22, the electromagnetic wave W21 and the electromagnetic wave W22 are shot into the spherical lens in parallel, and after being refracted by the spherical lens, the focal point is point B.

It can be seen from the figure that after the electromagnetic wave in any direction passes through the spherical lens, the focal point may finally be located on the spherical surface.

In the present embodiment, the material of the spherical lens is PTFE (Polytetrafluoroethylene). The PTFE is a polymer prepared by polymerizing tetra fluoroethylene as a monomer. The PTFE is in a shape of being white waxy and translucent, has characteristics of excellent heat resistance and cold resistance, low cost, etc., and may be used for a long time at −180° C. to 260° C.

Further, a dielectric constant of the spherical lens made based on the PTFE in the embodiment of the present disclosure is 2.08.

Further, a distance between the curved surface and a surface of the spherical lens is 0.4 R to 0.5 R, where the distance is a difference between the radius L of the curved surface and the radius R of the spherical lens.

Specifically, through a principle calculation and analog simulation, when the material of the spherical lens is the PTFE and the dielectric constant is 2.08, and the distance d from the spherical surface to the surface of the spherical lens is 0.4 R, the efficiency of the radar beacon is the highest. When the distance d is 0.5 R, the most flat aperture phase is obtained; and when d is further increased, aperture efficiency and a directivity diagram both become worse. Therefore, for the spherical lens of the embodiment of the present disclosure, the efficiency of the radar beacon is optimal when d is between 0.4 R and 0.5 R.

Since a corner reflector commonly used in the prior art is composed of three plane mirrors perpendicular to each other, the formed shape and structure makes the corner reflector have a large resistance to wind, and when wind force is strong, a phenomenon such as shaking may happen to the corner reflector, resulting in incapability of measurement of the radar measurement system or insufficient precision of the measurement result. However, the spherical lens in the present embodiment has a smooth and regular surface without a large undulation and a sharp edge and groove, so that the wind may bypass the spherical lens, the resistance to the wind is small, and the radar measurement system is not prone to being affected by the wind force and causing a measurement error.

In the present embodiment, the reflection apparatus 22 is arranged on the spherical surface, where the reflecting surface coincides with a portion of the spherical surface, and is provided with a reflecting surface with the same curvature as the spherical surface.

Further, the radar beacon further includes at least one fixing member connected between the reflection apparatus and the spherical lens for fixing a relative position of the reflection apparatus and the spherical lens.

In FIG. 3, the radar beacon further includes two fixing members 24a and 24b as an example for illustration, but the number of the fixing members is not limited in the embodiment of the present disclosure, which may be one or more than two.

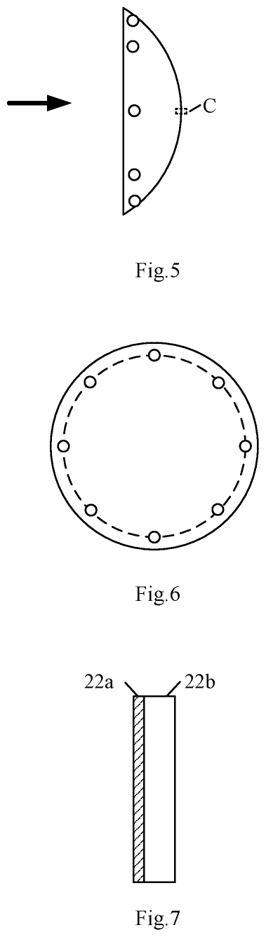

For example, taking the example that eight fixing members are provided for illustration, FIG. 5 is a perspective view of a reflection apparatus according to an embodiment of the present disclosure, and a small circle in the figure represents the fixing members, or a connection position of the fixing members. Among five small circles from top to bottom, the uppermost and lowermost small circles are one fixing member (or the connection position of the fixing members), and the three small circles in the middle are a coincident position of two fixing members (or the connection position of the fixing members).

Further, for the reflection apparatus in FIG. 5, the perspective view from the direction of an arrow is shown in FIG. 6, and the small circle in FIG. 6 represents the fixing members, or the connection position of the fixing members.

Further, the fixing members may connect the reflection apparatus and the spherical lens together in various existing manners. For example, the fixing members may connect the reflection apparatus to the spherical lens by means of screw connection or adhesive connection, etc.

Further, the reflection apparatus 22 includes a reflecting base plate and a reflecting surface. The reflecting surface is configured to reflect an electromagnetic wave, and the reflecting base plate is configured to support the reflecting surface.

Specifically, taking a portion C in a dotted box in FIG. 5 as an example for illustration, an enlarged structure is shown in FIG. 7, where the reflecting surface 22a is attached to the reflecting base plate 22b.

Further, the reflecting surface 22a of the reflection apparatus is made by a copper plating process, and coincides with a portion of the spherical surface.

Further, an outer edge of the reflecting base plate 22b is circular, so that the reflecting surface attached to the reflecting base plate can reflect electromagnetic waves in various directions.

Further, the reflecting base plate 22b may be made of various metals (except mercury) or non-metallic materials (for example, plastic, stone, and wood), etc.

Further, the radar beacon in the embodiment of the present disclosure further includes a support member 23, which is arranged under the spherical lens 21, and is configured to support the radar beacon.

Thus, the radar beacon may be placed in a suitable position through the support member 23.

It should be understood that in FIG. 3, illustration is made by taking the support member 23 being a cuboid as an example, but the shape of the support member is not limited in the embodiment of the present disclosure, and the support member 23 may also be in another shape, such as a cylinder, a prism (a triangular prism, a quadrangular prism, etc.) or another regular or irregular cylinder shape, and may also be set into a frame body, such as a tripod or a quadripod.

In an optional implementation, the support member 23 is fixedly connected to the spherical lens 21, and the specific fixing method may be being fixed by a screw or being bonded together.

In another optional implementation, the support member 23 is separated from the spherical lens 21. Specifically, when the support member 23 is in the shape of the cylinder, a circular groove may be formed at the top of the cylinder, and the groove matches the edge of at least a portion of the spherical lens, so that the spherical lens 21 can be placed on the support member stably. Or, the top of the cylinder is set to be flat, and correspondingly, the bottom of the spherical lens is also set to be flat. When the support member 23 is in the shape of the frame body, a circular ring may be arranged on the top of the frame body, so that the spherical lens 21 can be placed on the support member stably.

Radar Cross-Section (RCS) is a physical quantity of the echo intensity generated by the target under the illumination of a radar wave. Specifically, the radar target and scattered energy can be expressed as a product of effective area and incident power density. The area is often referred to as the RCS. RCS can be defined in terms of electromagnetic scattering theory. It is defined as 4x times the ratio of the power scattered by the target in a receiving direction within a unit solid angle to the power density of a plane wave shot into the target from a given direction.

Since the RCS of the target object changes drastically with the azimuth, it is also commonly expressed in dBsm (number of decibels per square meter). The specific formula is as follows:

σ₁=10 log₁₀(σ₂)

where σ₁ is the power per square meter, and σ₂ is the number of decibels per square meter.

It can be seen from the above formula that the number of decibels per square meter is reduced by 10 dBsm, and only 1/10 of echo power is left; the number of decibels per square meter is reduced by 20 dBsm, and only 1/100 of the echo power is left; and the number of decibels per square meter is reduced by 30 dBsm, and only 1/1000 of the echo power is left.

Further, for the corner reflector, the formula for calculating the radar cross-section area is:

$$σ ( max ) = \frac{4 π {A}^{2}}{3 {λ}^{2}}$$

where σ(max) is the maximum radar cross-section area, A is the side length of a square reflecting mirror surface of the corner reflector, and λ is the wavelength of the electromagnetic wave.

Further, for the spherical lens, the formula for calculating the radar cross-section area is:

$$σ ( max ) = \frac{{π}^{2} {d}^{2}}{4 {λ}^{2}}$$

where σ(max) is the maximum radar cross-section area, d is the diameter of the spherical lens, and A is the wavelength of the electromagnetic wave.

According to actual test results of the corner reflector in the prior art and the radar beacon in the embodiment of the present disclosure, it can be learned that:
when the corner reflector changes within 25° in the irradiation direction of the electromagnetic wave, the radar cross-section area may be kept basically unchanged; and
when the spherical radar beacon in the embodiment of the present disclosure changes between 90° and 180° in the irradiation direction of the electromagnetic wave, the radar cross-section area may be kept basically unchanged.

Thus, the radar beacon in the embodiment of the present disclosure may be used for radar measurement without accurately adjusting the radar beacon to an appropriate reflected angle with the radar, so that the installation of the radar beacon is facilitated.

According to the embodiments of the present disclosure, the incident electromagnetic wave is refracted to the reflection apparatus using the spherical lens, and the refracted electromagnetic wave is reflected via the reflection apparatus and then refracted by means of the spherical lens to form the echo signal so as to achieve the radar measurement, where the focal point of the spherical lens is located on the curved surface concentric with the spherical lens, the reflection apparatus is provided with the reflecting surface with the same curvature as the curved surface, and is arranged on the curved surface, and the reflecting surface coincides with a portion of the curved surface. Therefore, the radar beacon may be conveniently installed, the cost of the radar beacon is reduced, and the reflection efficiency of the radar beacon and the measurement precision of the radar measurement system are improved.

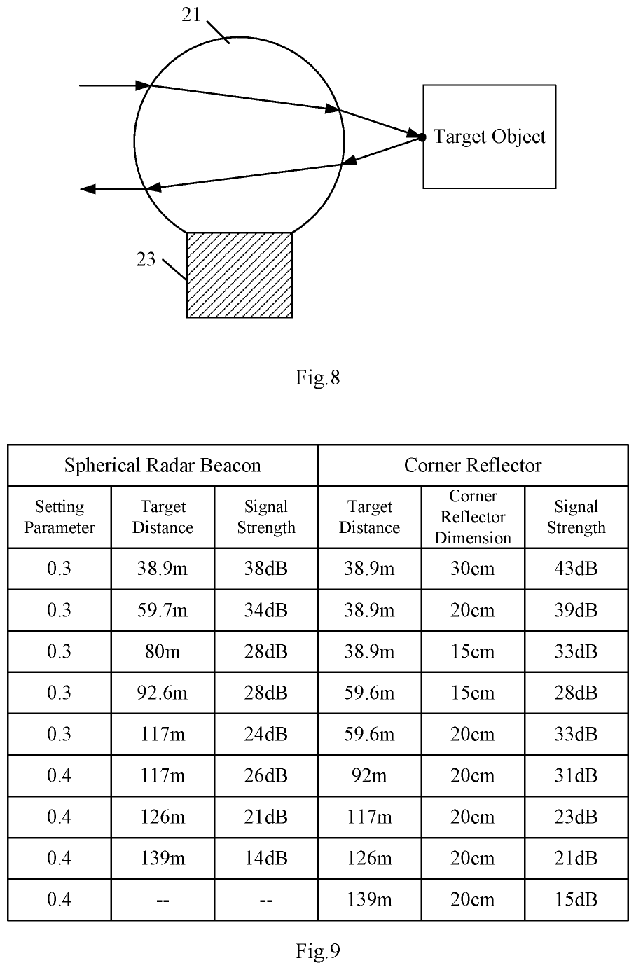

FIG. 8 is a schematic diagram of a radar beacon according to a second embodiment of the present disclosure. As shown in FIG. 8, in the embodiment of the present disclosure, the reflection apparatus is a portion of a target object.

Specifically, in some test scenarios, such as testing the deformation of a rail, the radar beacon needs to be placed close to the rail. When a vehicle passes the rail, a beacon apparatus may be touched, or, due to ground vibration and other reasons, the beacon apparatus is unbalanced. At this time, if there is a solid object (such as metal) in the beacon apparatus, the normal running of the vehicle may be affected, resulting in a serious consequence. Therefore, in the present embodiment, the reflection apparatus is not arranged in the beacon apparatus, and a portion of the target object is used as the reflection apparatus. That is, the beacon apparatus of the present embodiment only includes the spherical lens, and the target object is used as the reflection apparatus, so that the deformation of the target object may be measured relatively accurately.

Further, since being made of PTFE, the spherical lens is easily deformed or damaged when subjected to pressure. As a result, even if falling on the rail during the test, the spherical lens may be instantly destroyed when subjected to the pressure from the vehicle, which will not affect the normal running of the vehicle.

According to the embodiments of the present disclosure, the incident electromagnetic wave is refracted to the reflection apparatus using the spherical lens, and the refracted electromagnetic wave is reflected via the reflection apparatus and then refracted by means of the spherical lens to form the echo signal so as to achieve the radar measurement, where the focal point of the spherical lens is located on the curved surface concentric with the spherical lens, the reflection apparatus is provided with the reflecting surface with the same curvature as the curved surface, and is arranged on the curved surface, and the reflecting surface coincides with a portion of the curved surface. Therefore, the radar beacon may be conveniently installed, the cost of the radar beacon is reduced, and the reflection efficiency of the radar beacon and the measurement precision of the radar measurement system are improved.

Further, taking X-band radar as an example for illustration, under different setting parameters and target distances, test parameters of the spherical radar beacon and the corner reflector are shown in FIG. 9, where the setting parameter is resolution, and the target distance is the distance from the measurement radar to the radar beacon, the corner reflector dimension is the side length of the square reflecting mirror surface of the corner reflector, and the spherical radar beacon refers to the radar beacon in the embodiment of the present disclosure. The test parameter of the spherical radar beacon is the test parameter of the spherical radar beacon having a diameter of 20 cm. According to the data in FIG. 9, it can be seen that:

when the target distance is less than 80 meters and the corner reflector dimension is 15 cm, the signal-to-noise ratio of the spherical radar beacon is 5 dB to 6 dB stronger than the signal-to-noise ratio of the corner reflector. When the corner reflector dimension is 20 cm, the signal-to-noise ratio of the spherical radar beacon is almost the same as the signal-to-noise ratio of the corner reflector.

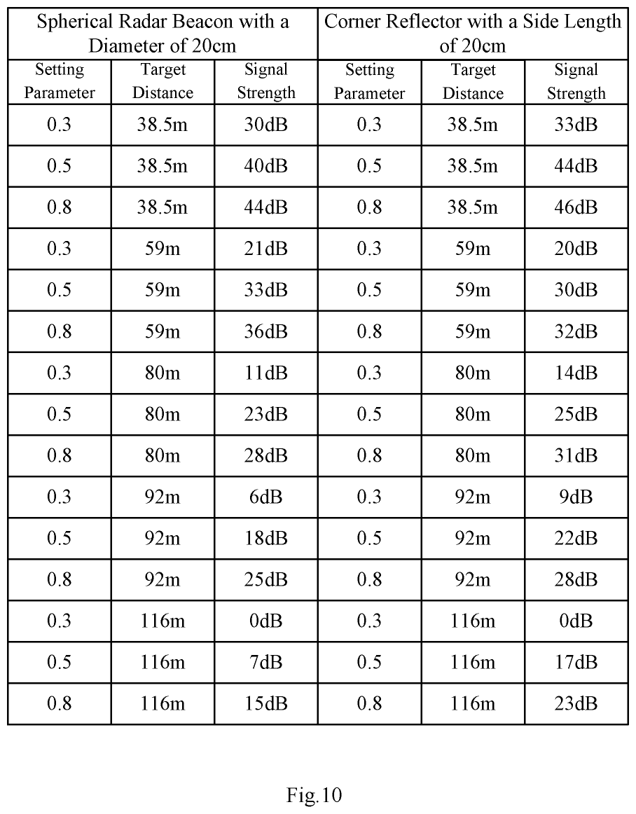

Further, taking K-band radar as an example for illustration, the test parameters of the corner reflector with the square reflecting mirror surface having a side length of 20 cm and the spherical radar beacon having a diameter of 20 cm are shown in FIG. 10, where the setting parameter is the resolution, the target distance is the distance from the measurement radar to the radar beacon, and the spherical beacon is the radar beacon in the embodiment of the present disclosure. Comparing the test data of the spherical radar beacon and the corner reflector in FIG. 10, it may be learned that:
when the target distance is 38.5 meters, the signal-to-noise ratio of the corner reflector is 3 dB higher than the signal-to-noise ratio of the spherical beacon on average;
when the target distance is 59 meters, the signal-to-noise ratio of the corner reflector is 3 dB lower than the signal-to-noise ratio of the spherical beacon on average;
when the target distance is 80 meters, the signal-to-noise ratio of the corner reflector is 3 dB higher than the signal-to-noise ratio of the spherical beacon on average;
when the target distance is 92 meters, the signal-to-noise ratio of the corner reflector is 3 dB higher than the signal-to-noise ratio of the spherical beacon on average;
when the target distance is 116 meters, the spherical beacon can no longer add the target, and the signal-to-noise ratio of the corner reflector is 20 dB.

It can be seen from the above comparison result that when the diameter of the spherical lens and the side length of the corner reflector are both 20 cm and the target distance is 59 meters to 80 meters, the efficiency of the spherical beacon is higher. Therefore, the diameter of the spherical lens of the embodiment of the present disclosure can be set according to different application scenarios, so as to achieve the highest efficiency.

Optionally, when the radius length of the spherical lens is 12 cm or 21 cm, high efficiency can be maintained in most application scenarios.

According to the embodiments of the present disclosure, the incident electromagnetic wave is refracted to the reflection apparatus using the spherical lens, and the refracted electromagnetic wave is reflected via the reflection apparatus and then refracted by means of the spherical lens to form the echo signal so as to achieve the radar measurement, where the focal point of the spherical lens is located on the curved surface concentric with the spherical lens, the reflection apparatus is provided with the reflecting surface with the same curvature as the curved surface, and is arranged on the curved surface, and the reflecting surface coincides with a portion of the curved surface. Therefore, the radar beacon may be conveniently installed, the cost of the radar beacon is reduced, and the reflection efficiency of the radar beacon and the measurement precision of the radar measurement system are improved.

The above description is only the preferred embodiment of the present disclosure and is not intended to limit the present disclosure, and various modifications and changes may be made in the present disclosure for those skilled in the art. Any modification, equivalent replacement, improvement, and the like made within the spirit and principle of the present disclosure should fall within the protection scope of the present disclosure.

1. A radar beacon, comprising:
a spherical lens, of which a focal point is located on a curved surface concentric with the spherical lens; and
a reflection apparatus, which is provided with a reflecting surface with the same curvature as the curved surface, is arranged on the curved surface, wherein the reflecting surface coincides with a portion of the curved surface, and is configured to reflect an electromagnetic wave incident through the spherical lens.

2. The radar beacon according to claim 1, wherein the material of the spherical lens is Polytetrafluoroethylene (PTFE).

3. The radar beacon according to claim 1, wherein the distance between the curved surface and a surface of the spherical lens is 0.4 R to 0.5 R, wherein R is the radius of the spherical lens.

4. The radar beacon according to claim 1, wherein the radar beacon further comprises:
at least one fixing member, which is connected between the reflection apparatus and the spherical lens, and is configured to fix a relative position of the reflection apparatus and the spherical lens.

5. The radar beacon according to claim 1, wherein the radar beacon further comprises:
a support member, which is arranged under the spherical lens, and is configured to support the radar beacon.

6. The radar beacon according to claim 1, wherein the reflecting surface of the reflection apparatus is made by a copper plating process.

7. The radar beacon according to claim 1, wherein the reflection apparatus further comprises a reflecting base plate, and the reflecting surface is attached to the reflecting base plate.

8. The radar beacon according to claim 7, wherein an outer edge of the reflecting base plate is circular.

9. The radar beacon according to claim 1, wherein the reflection apparatus is a portion of a target object.

10. A radar measurement system, comprising:
a measurement radar; and
at least one radar beacon according to claim 1.
